(19) United States
(12) Patent Application Publication
(10) Pub. No.: US 2022/0083927 A1
(43) Pub. Date: Mar. 17, 2022

(54) SYSTEM FOR CLIENT AND RESOURCE MANAGEMENT IN THE ELECTRONIC DEVICE REPAIR INDUSTRY

(71) Applicant: Raymond Cordero Vargas, Aguada, PR (US)

(72) Inventor: Raymond Cordero Vargas, Aguada, PR (US)

(21) Appl. No.: 17/023,895

(22) Filed: Sep. 17, 2020

(51) Int. Cl. G06Q 10/06; G06Q 10/00; G06Q 10/08; G06Q 10/10; G06Q 20/20; G06Q 30/02; G06F 16/2457; G06F 16/22; G06F 3/0482

(52) U.S. Cl. CPC G06Q 10/0631; G06Q 10/20; G06Q 10/0875; G06Q 10/109; G06Q 20/203; H04L 67/42; G06Q 30/0201; G06Q 10/103; G06F 16/24578; G06F 16/22; G06F 3/0482; G06Q 20/202

(57) ABSTRACT

A resource management system for an electronic device repair service is disclosed, the system comprising a user database to store information corresponding to at least one client and at least one employee. An inventory database stores inventory information corresponding to a plurality of parts associated with an electronic device repair process. A business database stores sales analytics associated with a business. A business analytics engine is in operable communication with a POS system to receive a plurality of sales information. The sales analytics module receives and displays the plurality of sales information on a display of a user device. A report generator generates a report of the plurality of sales information, while an order generation module generates an order for at least one of the plurality of parts associated with the electronic device repair process. A scheduling module schedules a repair for the electronic device.

### TECHNICAL FIELD

The embodiments generally relate to computerized systems for client and resource management and, more particularly, relate to systems and methods to allow an electronic device repair service to manage client relations, schedule appointments, manage inventory, and perform the various functions related to electronic device repair.

### BACKGROUND

Businesses must manage the various processes that are necessary for performing the various operations of the business. Companies often make large investments into the implementation of platforms and the development of business processes related to client relationship management (CRM) systems, point-of-sale (POS) systems, inventory management systems, internal communication systems, scheduling systems, and the like. Many of these platforms are outside the financial limitations of smaller businesses, which rely on paper-based information systems or rudimentary software that requires the user to manually input a large portion of the information.

In the current arts, many CRM systems are utilized at the direction of a representative of the business, without the ability for clients to collaboratively schedule an event with the business. Further, many CRM systems do not communicate with other systems relevant to the business. For example, when a client requires a repair for their electronic device, the user calls or otherwise contacts the business to schedule a repair. The client may then indicate what is wrong with the electronic device and leave the electronic device at the business for repair. The service professional may then diagnose the problem and determine a solution, which may include using an ordering system to order the necessary components to fix the problem. The entire process has various bottlenecks, which can be prevented with a comprehensive client and resource management system.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a resource management system for an electronic device repair service, the system comprising a user database to store information corresponding to at least one client and at least one employee. An inventory database stores inventory information corresponding to a plurality of parts associated with an electronic device repair process. A business database stores sales analytics associated with a business. A business analytics engine is in operable communication with a POS system to receive a plurality of sales information. The sales analytics module receives and displays the plurality of sales information on a display of a user device. A report generator generates a report of the plurality of sales information, while an order generation module generates an order for at least one of the plurality of parts associated with the electronic device repair process. A scheduling module schedules a repair for the electronic device.

The system provided herein can be used by an electronic device repair business from the client intake process, the invoice generation and repair process, through to the payment processing and sale of auxiliary goods, without requiring the integration of auxiliary programs commonly used in the arts. The system is provided to give an easy-to-use all-in-one system for executing various business processes and analyzing business analytics. The system may allow the business to select and monitor monthly, quarterly, or yearly goals while viewing sales metrics for each client or over a period of time.

In one aspect, the business analytics interface further comprises a monthly goal interface to illustrate a current sales total with the monthly goal of the business.

In one aspect, the business analytics interface includes a number of repairs, a number of appointments, and a number of orders.

In one aspect, the business analytics interface includes a quick actions interface comprising a plurality of selectable tabs for actions to be performed by the at least one employee.

In one aspect, a quick repair interface includes a plurality of information related to the electronic device. The plurality of information includes at least one of the following: a type, a device identifier, a cost, and a defective part.

In one aspect, a business task interface displays a plurality of tasks associated with the business. The tasks comprise at least one of the following: a plurality of pending repairs, a plurality of upcoming appointments, and a plurality of upcoming repairs.

In one aspect, a repairs interface permits the employee to provide at least one of the following: the client's information and the repair information.

In one aspect, the repairs interface further comprises a monthly overview window to permit the user to view monthly goals.

In one aspect, an inventory module displays up-to-date inventory information to the display of the computing device.

In one aspect, the inventory module is in operable communication with the order generation module to execute the generation of the order.

In one aspect, a communications module permits an employee to communicate with a client.

In one aspect, a client ranking generator ranks clients in view of the client's sales history.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the application system, according to some embodiments;

FIG. 3 illustrates a block diagram of the server engine and modules, according to some embodiments;

FIG. 4 illustrates a block diagram of the business analytics engine, according to some embodiments;

FIG. 5 illustrates a screenshot of the home screen interface, according to some embodiments;

FIG. 6 illustrates a screenshot of the business analytics interface, according to some embodiments;

FIG. 7 illustrates a screenshot of the repair listing interface, according to some embodiments;

FIG. 8 illustrates a screenshot of the quick repair interface, according to some embodiments;

FIG. 9 illustrates a screenshot of the quick actions interface, according to some embodiments;

FIG. 10 illustrates a screenshot of the client service interface, according to some embodiments;

FIG. 11 illustrates a screenshot of the business task interface, according to some embodiments;

FIG. 12 illustrates a screenshot of the repairs interface, according to some embodiments;

FIG. 13 illustrates a screenshot of the electronic device information interface, according to some embodiments;

FIG. 14 illustrates screenshots of the repair overview interfaces, according to some embodiments;

FIG. 15 illustrates a screenshot of the purchase orders interface, according to some embodiments;

FIG. 16 illustrates a screenshot of the purchase order generation interface, according to some embodiments; and

FIG. 17 illustrates a screenshot of the meetings interface, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a client relations and resource management system, which allows for an electronic device repair business to manage client intake, scheduling of a meeting and/or repair, client communications, inventory management, ordering of components, and to manage employees and other resources. The system includes various modules to assist the user in managing all aspects of the electronic device repair business in a single platform while simplifying various business processes and sales analytics to facilitate the growth and standard operation of the business.

As used herein, the term “user” may relate to a client of the business or to an employee and/or representative of the business. Each form of user may utilize the system for communications therebetween, scheduling of appointments and services, etc. The employee may use the system to manage the client intake process, manage an order, document a repair and the processes thereof, manage employee resource, manage inventory, track and analyze business analytics (e.g., sales goals, etc.), and the like.

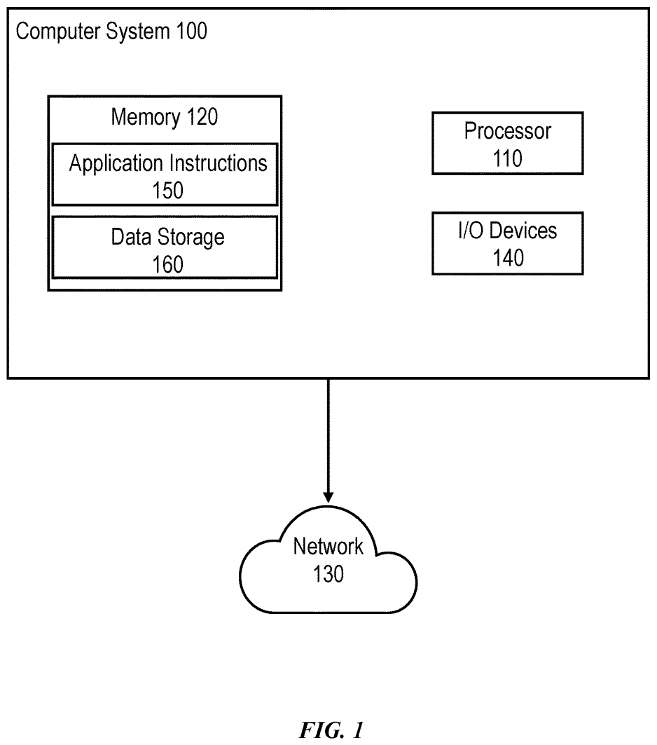

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The memory may be utilized to store product inventory, product information, employee information, scheduling information, business information, client information, and the like.

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

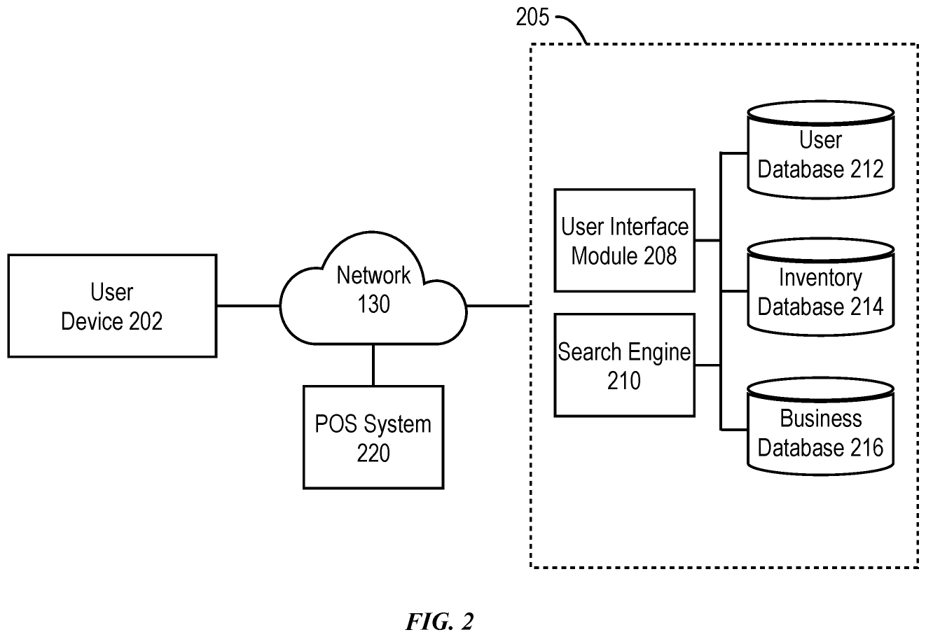

FIG. 2 illustrates a block diagram of the application system 200 in operable communication with a user device 202 via a network 130. The user device 202 may be a client computing device or an employee/business representative computing device, which is used to access and operate the application system 205. The application system 205 includes a user interface module 208 to provide a plurality of information onto the display of the user device 208. The information contained in a plurality of databases (e.g., user database 212, inventory database 214, and business database 216) can be searched via the search engine 210 and displayed via the user interface module 208. The user database 212 stores user information including contact information, service history, scheduling availability etc. The inventory database 214 stores product inventory information and may be in operable communication with the POS system 220 to process payments from clients. The inventory database may display up-to-date inventory data in real time on the user device 202, such that the employee can accurately predict availability and locations of products needed for a repair. The business database 216 stores business information including business location, contact information, sales data, and the like.

In some embodiments, the POS system is in operable communication with a payment terminal or cloud-based payment processing system to execute and receive the payment from the client. The POS system may be capable of receiving a deposit from the client or issuing a refund to the client.

In some embodiments, the application system 200 may be in operable communication with an e-commerce platform to allow the user to shop for parts and accessories related to their electronic device.

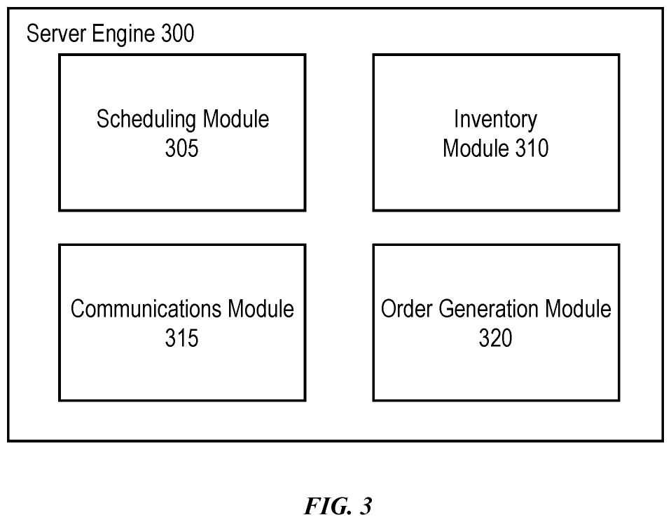

FIG. 3 illustrates the server engine 300 and modules thereof comprising a scheduling module 305, an inventory module 310, a communications module 315, and an order generation module 320. The scheduling module 305 receives availability from the employee, business representative or groups thereof in addition to business hours of operation at various locations. The scheduling module 305 may then receive a request from the client to set up an appointment, service, etc. and reference the employee's and business's schedule to determine if the requested time is accepted or denied. If accepted, the scheduling module 305 will input the appropriate information into a calendar, which may be viewed by the user device. The inventory module 310 receives inventory data from the user device, POS system, or other associated device to provide inventory data in real-time. The inventory data may include a product identification number, product features, product location, and other product information. A communications module 315 permits two or more users to communicate with one another using remote computing devices. Communications may be used to schedule appointments, schedule a service, and the like. An order generation module 320 permits the employee to place an order for one or more components of an electronic device. The order generation module 320 may be in operable communication with the inventory module to determine availability of a product that is ordered. In such, the order generation module 320 may output an estimated completion date of the service/repair of the electronic device based on the scheduled time and date of the original appointment, project lead time required to complete the repair/service, and the time needed to order and receive one or more parts, which may need to be ordered from a separate location.

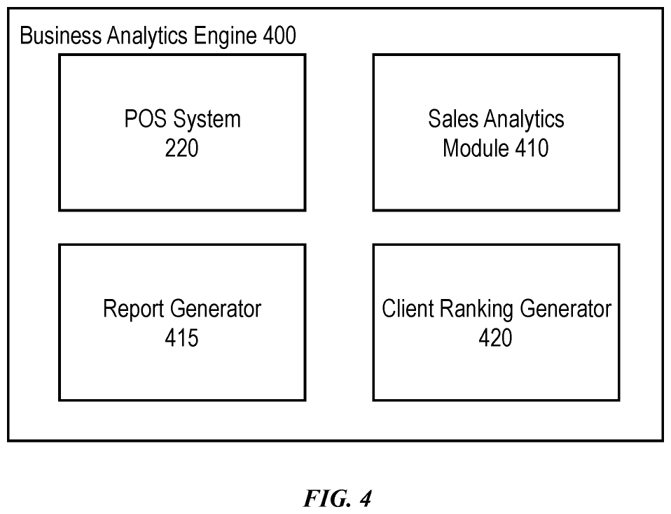

FIG. 4 illustrates a block diagram of the business analytics engine 400 comprising the POS system 220, which receives sales information at the time of the sale. A sales analytics module 410 displays sales data on a sales analytics interface to permit the employee/business representative to view historical and/or current sales data. A report generator 415 generates a report of sales information, which may be categorized by time (e.g., sales in a particular month), by client (e.g., sales to a particular client), by product, by electronic device (e.g., sales related to the repair of a particular smartphone), by employee (e.g., total sales amount by each employee of the business), and the like. A client ranking generator 420 ranks clients by one of a plurality of sales metrics and displays the rankings to the employee/business representative.

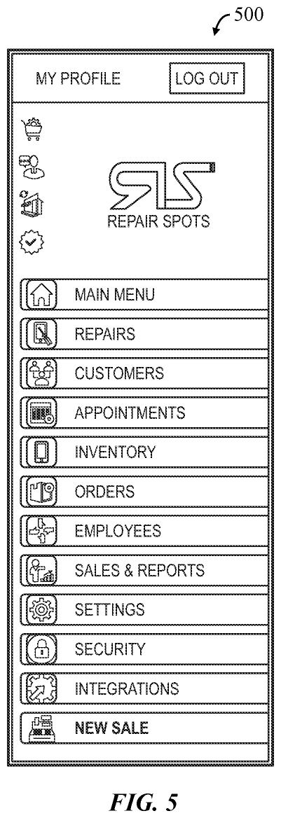

FIG. 5 illustrates a screenshot of the home screen interface 500 comprising a plurality of selectable tabs including: a main menu tab to direct the user to the main menu, a repairs tab to direct the user to the repairs interface, a customers tab to direct the user to a customer information interface, an appointments tab to direct the user to an appointments and meetings interface, an inventory tab to direct the user to an inventory interface in operable communication with the inventory database, an orders tab to direct the user to the orders interface, an employee tab to direct the user to the employee interface, a sales and reports tab to direct the user to the sales analytics interface, a settings tab to direct the user to the settings interface, a security tab to direct the user to the security preferences interface, an integrations tab to direct the user to an integration interface and integration interface, and a new sale tab to direct the user to a new sale interface.

In some embodiments, each user may be assigned user permissions via an administrative user. Alternatively, user permissions may be defined by the user's identity (e.g., client, employee, administrator, manager, etc.), such that each user has access to various features of the system.

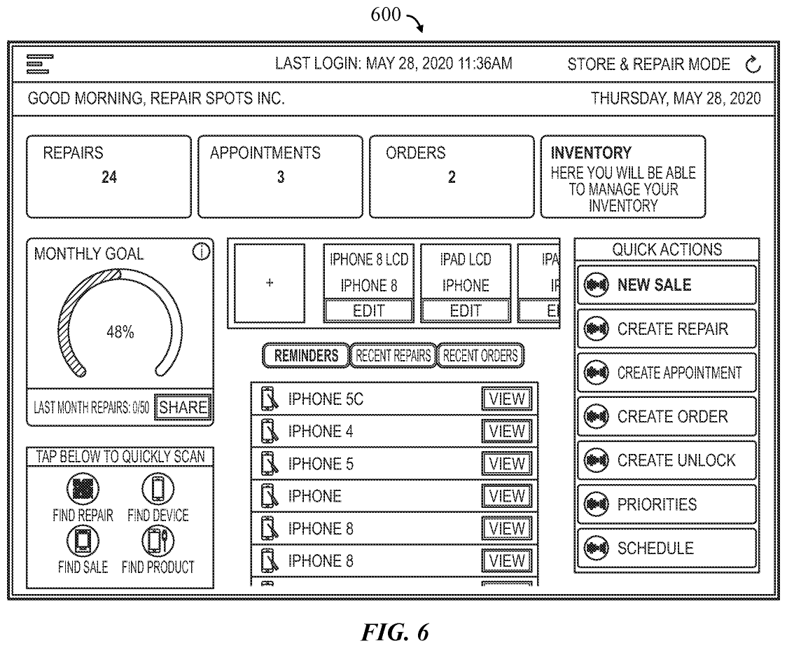

FIG. 6 illustrates a screenshot of the business analytics interface 600 wherein the user can view sales information, including the number of repairs, appointments, orders, and inventory. A monthly goal meter will facilitate the visualization of the businesses progress towards a monthly sales goal. The business analytics interface 600 may also include various subsets for initiating processes of the system, including a quick actions subset allowing the user to initiate a sale, create a repair, create an appointment, create an order, establish priorities, schedule an event, etc. One skilled in the arts will readily understand that the business analytics interface 600 may be customized by the user to display relevant information to the user or to the business. A repair subset is created to allow the user to view current repairs for a plurality of electronic devices.

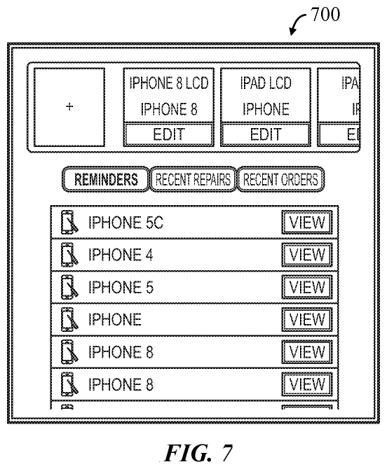

FIG. 7 illustrates a screenshot of the repair listing interface 700 wherein the user can view and interact with information associated with a plurality of repairs for electronic devices. For example, a plurality of electronic devices may be listed, which are currently under repair. The user may select a view tab to view information related to the repair of the electronic device (e.g., the problem with the electronic device, the component needed to fix the problem, etc.). The user may also edit repair details for each electronic device, view recent repairs, and view recent orders.

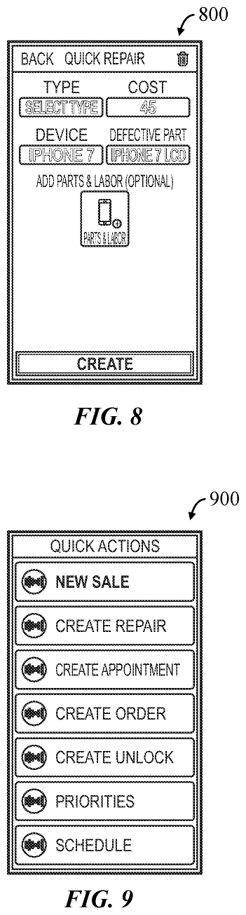

FIG. 8 illustrates a screenshot of the quick repair interface 800 wherein the user selects a type of the repair, cost of the repair, electronic device being repaired, the part needed to correct the problem (e.g., replacement for defective part), and the option to add a parts and labor costs to the repair. The quick repair interface 800 allows the user to easily provide the necessary details required to begin the repair process, order one or more parts, and create an invoice for the client based on the cost of parts and labor.

In some embodiments, the user may be able to notify the customer of a repair status, such as that the repair is delayed, completed, etc. throughout the process of the repair.

FIG. 9 illustrates a screenshot of the quick actions interface 900 permitting the user to select a plurality of tabs, including tabs to initiate a sale, create a repair, create an appointment, create an order, establish priorities, and schedule an event. In such, the user can utilize the quick actions interface 900 to perform many of the features of the system described hereinabove.

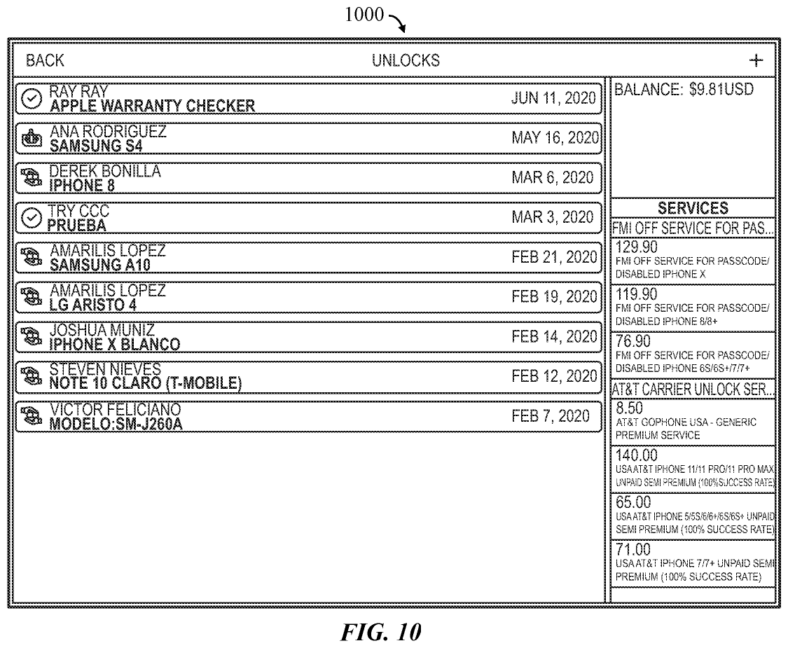

FIG. 10 illustrates a screenshot of the client service interface 1000 wherein the client is unlocking their electronic device. The client service interface 1000 displays a client listing including the client name and electronic device type for the device which is being unlocked. A balance of fees may be displayed for various tasks associated with the unlock process, the client's history of repairs, etc.

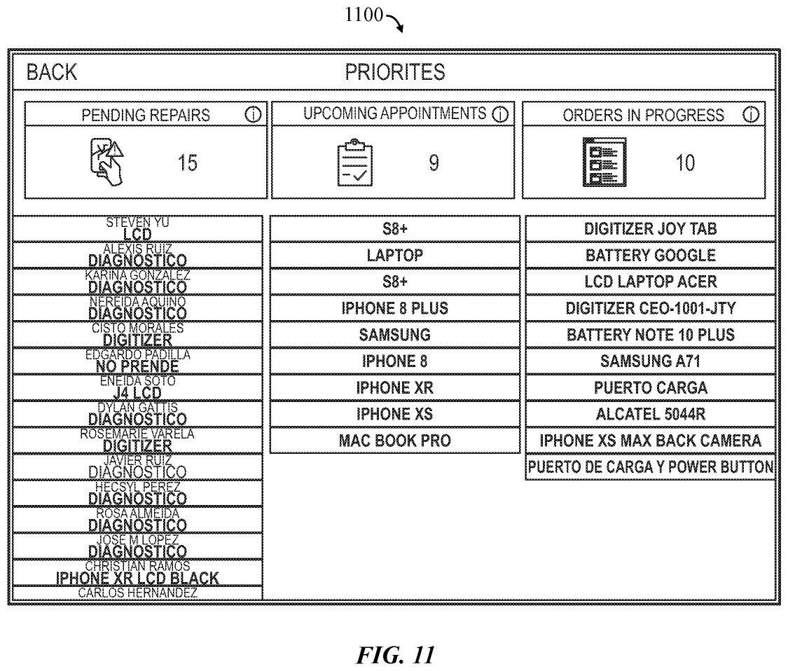

FIG. 11 illustrates a screenshot of the business task interface 1100 wherein a plurality of tasks are displayed including the pending repairs and information thereof, upcoming appointments and associated information thereof, and order in progress and associated information thereof. The business task interface may be sorted by priority of each task, such that the user is provided with a to-do list of various tasks associated with the repair and service of electronic products.

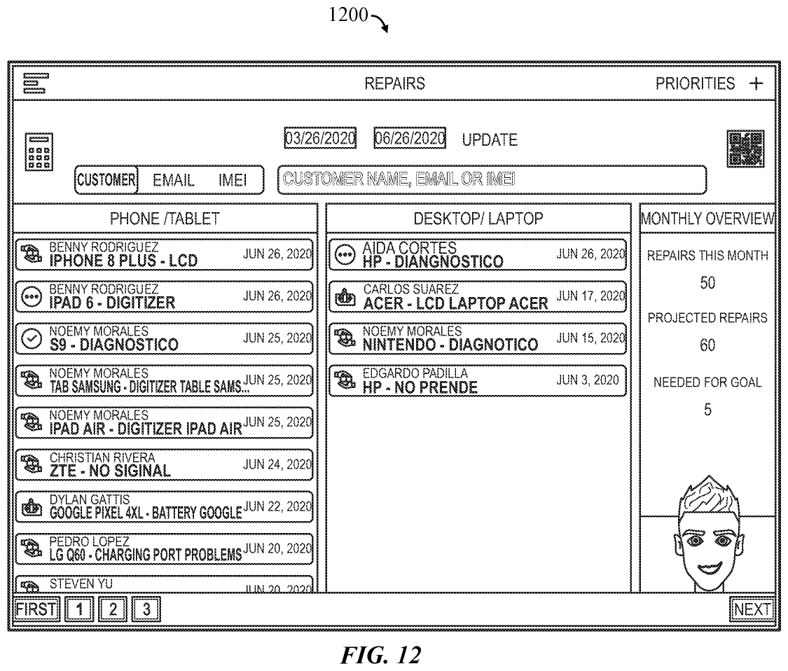

FIG. 12 illustrates a screenshot of the repairs interface 1200 wherein a plurality of information related to various repairs is illustrated. The user may sort a repair listing by customer information, email, device identifier, etc. to view a listing of the various projects which are underway by one or more employees of the business. The listing may also be separated by electronic device type (e.g., cellphone, laptop, tablet, etc.). A monthly overview window illustrates metrics related to the business including monthly goals, repairs completed, projected repairs for the month, and number of repairs needed to reach the monthly goal. One skilled in the arts will readily understand that the monthly overview window may display other data including sales analytics and the like.

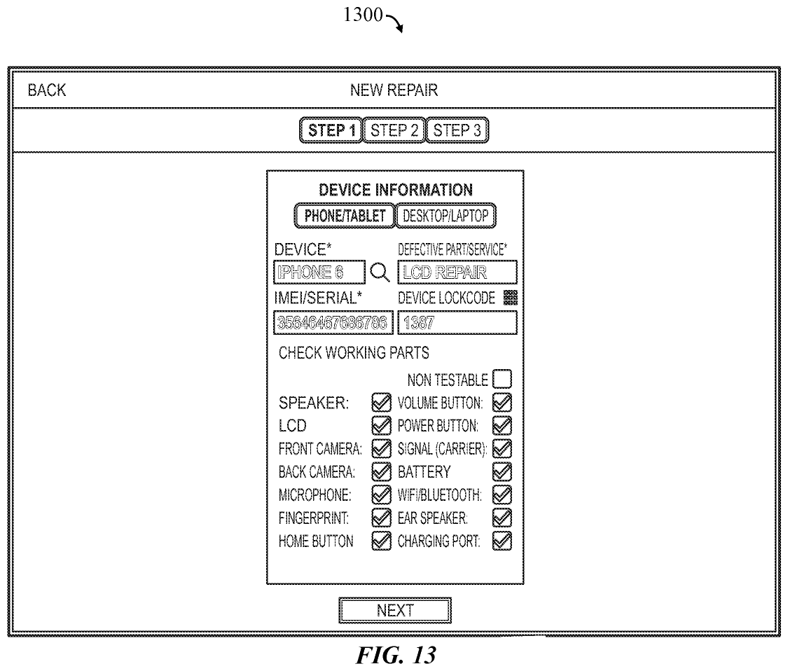

FIG. 13 illustrates a screenshot of the electronic device information interface 1300 wherein the user is creating a new repair and inputting information related to the electronic device being repaired. For example, the user may enter the type of electronic device (e.g., cellphone, tablet, desktop computer, or laptop computer), the device identification number, defective parts, serial number, device lock code, and a parts list to indicate working or broken parts on the device.

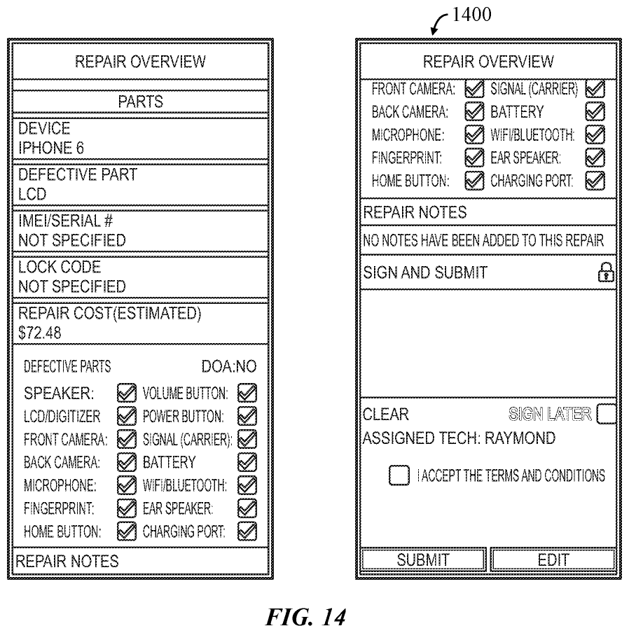

FIG. 14 illustrates screenshots of the repair overview interface 1400 wherein information displayed in the electronic device information interface 1300 (FIG. 13) is associated with a pending or completed repair of the electronic device. The repair overview interface 1400 allows the user to input repair notes, sign and submit the completed repair, view the assigned employee who is completing or has completed the repair, and the like. In such, the business and client alike are provided with a complete list of the repair strategy, including new parts, replaced parts, and other aspects of the repair process. In such, the employee is able to verify the initiation and/or completion of a repair by reviewing the details related to the repair and providing a signature to verify the process is underway or complete.

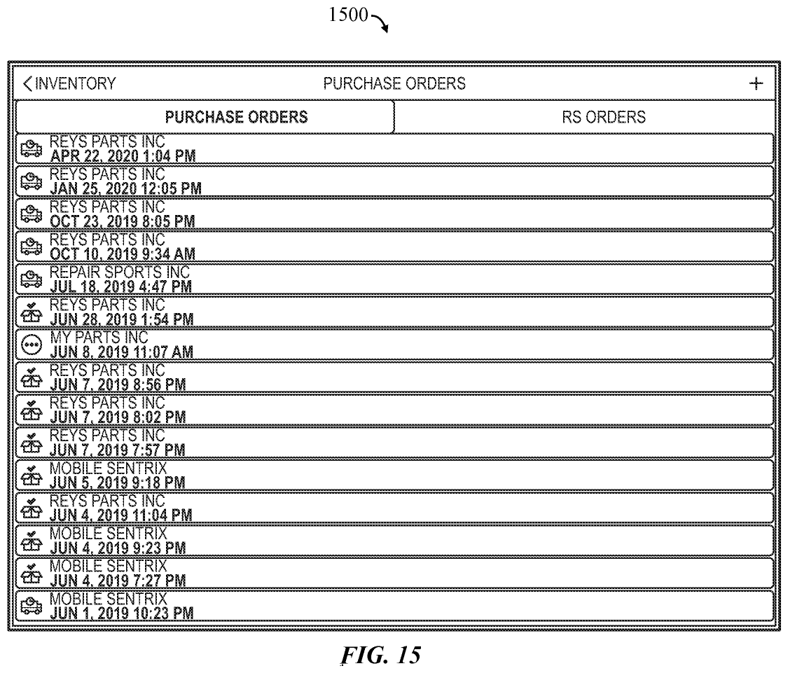

FIG. 15 illustrates a screenshot of the purchase orders interface 1500 wherein the user is able to view purchase orders placed related to one or more repairs performed by the business. For example, the user can navigate through purchase orders interface 1500 for purchase orders related to a particular client, a particular electronic device, or for a complete listing of purchase orders made over a period of time.

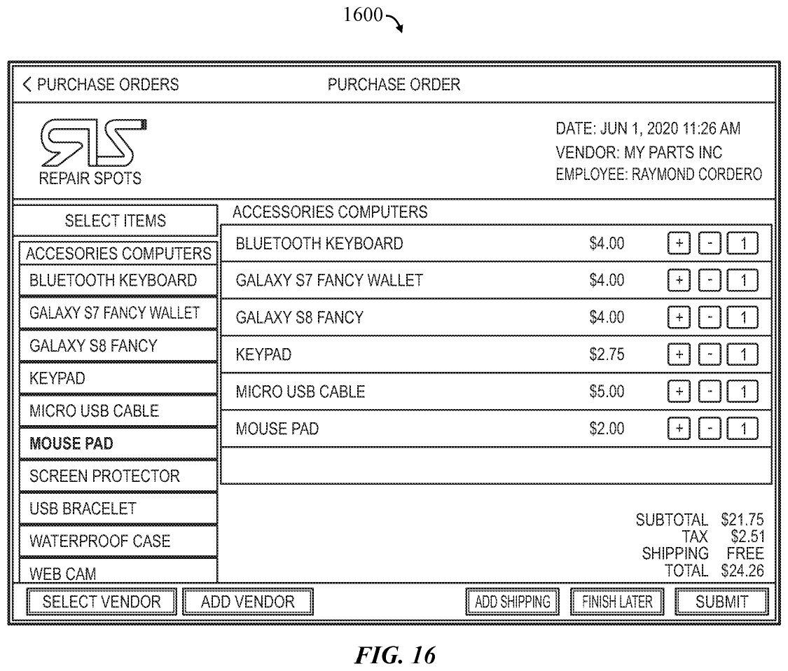

FIG. 16 illustrates a screenshot of the purchase order generation interface 1600 wherein the user can create a purchase order corresponding to one or more electronic devices and the repair/service thereof. Further, the user may utilize the purchase order generation interface 1600 to order aftermarket parts and accessories for the electronic device (e.g., Bluetooth keyboards, headphones, cameras, mouse pads, keypads, USB cables, and the like).

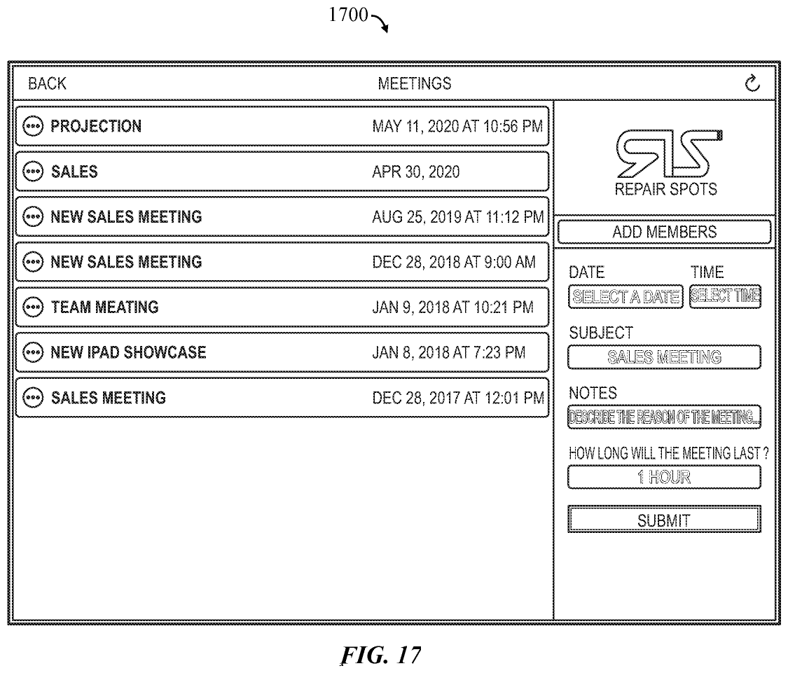

FIG. 17 illustrates a screenshot of the meetings interface 1700, which allows the user to schedule meetings with clients, employees, service providers, manufacturers, accessory providers, and others associated with the business of repairing and servicing electronic devices. The meeting interface 1700 is in operable communication with the scheduling module to provide a comprehensive schedule for any scheduled client meetings, service and repairs, etc.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A resource management system for an electronic device repair service, the system comprising:
a user database to store information corresponding to at least one client and at least one employee;
an inventory database to store inventory information corresponding to a plurality of parts associated with an electronic device repair process;
a business database to store sales analytics associated with a business;
a business analytics engine in operable communication with a POS system to receive a plurality of sales information, and a sales analytics module to receive and display the plurality of sales information on a display of a user device, wherein a report generator generates a report of the plurality of sales information;
an order generation module to generate an order for at least one of the plurality of parts associated with the electronic device repair process; and
a scheduling module to schedule a repair for the electronic device.

2. The system of claim 1, further comprising an inventory module to display up-to-date inventory information to the display of the computing device.

3. The system of claim 2, wherein the inventory module is in operable communication with the order generation module to execute the generation of the order.

4. The system of claim 3, further comprising a communications module to permit an employee to communicate with a client.

5. The system of claim 4, further comprising a client ranking generator to rank clients in view of the client's sales history.

6. A resource management system for an electronic device repair service, the system comprising:
a user database to store information corresponding to at least one client and at least one employee, wherein the at least one client's information is provided on a repairs interface;
an inventory database to store inventory information corresponding to a plurality of parts associated with an electronic device repair process;
a business database to store sales analytics associated with a business;
a business analytics engine in operable communication with a POS system to receive a plurality of sales information, and a sales analytics module to receive and display the plurality of sales information on a display of a user device, wherein a report generator generates a report of the plurality of sales information and display the plurality of sales information on a business analytics interface;
an order generation module to generate an order for at least one of the plurality of parts associated with the electronic device repair process; and
a scheduling module to schedule a repair for the electronic device.

7. The system of claim 6, wherein the business analytics interface further comprises a monthly goal interface to illustrate a current sales total with the monthly goal of the business.

8. The system of claim 7, wherein the business analytics interface includes a number of repairs, a number of appointments, and a number of orders.

9. The system of claim 8, wherein the business analytics interface includes a quick actions interface comprising a plurality of selectable tabs for actions to be performed by the at least one employee.

10. The system of claim 9, further comprising a quick repair interface including a plurality of information related to the electronic device.

11. The system of claim 10, wherein the plurality of information includes at least one of the following: a type, a device identifier, a cost, and a defective part.

12. The system of claim 11, further comprising a business task interface to display a plurality of tasks associated with the business.

13. The system of claim 12, wherein the tasks comprise at least one of the following: a plurality of pending repairs, a plurality of upcoming appointments, and a plurality of upcoming repairs.

14. The system of claim 13, further comprising a repairs interface wherein the employee provides at least one of the following: the client's information, and the repair information.

15. The system of claim 14, wherein the repairs interface further comprises a monthly overview window to permit the user to view monthly goals.

16. The system of claim 15, further comprising an inventory module to display up-to-date inventory information to the display of the computing device.

17. The system of claim 16, wherein the inventory module is in operable communication with the order generation module to execute the generation of the order.

18. The system of claim 17, further comprising a communications module to permit an employee to communicate with a client.

19. The system of claim 18, further comprising a client ranking generator to rank clients in view of the client's sales history.

20. A resource management system for an electronic device repair service, the system comprising:
a user database to store information corresponding to at least one client and at least one employee, wherein the at least one client's information is provided on a repairs interface;
an inventory database to store inventory information corresponding to a plurality of parts associated with an electronic device repair process;
a business database to store sales analytics associated with a business;
a business analytics engine in operable communication with a POS system to receive a plurality of sales information, and a sales analytics module to receive and display the plurality of sales information on a display of a user device, wherein a report generator generates a report of the plurality of sales information and display the plurality of sales information on a business analytics interface;
a repair interface to permit the at least one employee to initiate a repair and to view current repairs, the repair interface in operable communication with an order generation module to generate an order for at least one of the plurality of parts associated with the electronic device repair process;
a repair overview interface to display details associated with the repair process, wherein the repair overview interface permits the employee to verify the repair; and
a scheduling module to schedule a repair for the electronic device.
